(19) United States
(12) Patent Application Publication
(10) Pub. No.: US 2026/0016951 A1
(43) Pub. Date: Jan. 15, 2026

(54) ELECTRONIC DEVICE FOR SUPPORTING XR CONTENT, AND INPUT MODE SUPPORT METHOD THEREFOR

(71) Applicant: SAMSUNG ELECTRONICS CO., LTD., Suwon-si (KR)

(72) Inventors: Sungkwang YANG, Suwon-si (KR); Kwangtai KIM, Suwon-si (KR); Seungnyun KIM, Suwon-si (KR); Jaekyu SHIM, Suwon-si (KR); Jongmin YOON, Suwon-si (KR); Joungmin CHO, Suwon-si (KR)

(73) Assignee: SAMSUNG ELECTRONICS CO., LTD., Suwon-si (KR)

(21) Appl. No.: 19/334,330

(22) Filed: Sep. 19, 2025

Related U.S. Application Data
(63) Continuation of application No. PCT/KR2024/095565, filed on Mar. 15, 2024.

(30) Foreign Application Priority Data
Mar. 21, 2023 (KR) 10-2023-0036723
Apr. 21, 2023 (KR) 10-2023-0052834

(51) Int. Cl. G06F 3/04883; G02B 27/00; G02B 27/01; G06F 3/01

(52) U.S. Cl. CPC G06F 3/04883; G02B 27/0093; G02B 27/0172; G06F 3/012; G06F 3/013; G02B 2027/0138

(57) ABSTRACT

An electronic device includes: a body; a display facing a first direction; a touch sensor facing in a second direction; first cameras facing the second direction; at least one processor; and memory storing instructions, wherein the instructions, when executed by the at least one processor individually or collectively, to cause the electronic device to: control the display to output an extended reality (XR) content screen including at least one virtual object; based on identifying that a hand of the user is within a first distance from the touch sensor, control the display to change the hand of the user displayed in the XR content screen to a virtual pointer object; based on a touch input being detected via the touch sensor, control the display to display a virtual area frame including the virtual pointer object; and control motion of the virtual pointer object in the virtual area frame.

### CROSS-REFERENCE TO RELATED APPLICATIONS

This application is a bypass continuation application of International Application No. PCT/KR2024/095565, filed on Mar. 15, 2024, which claims priority to Korean Patent Application No. 10-2023-0036723, filed on Mar. 21, 2023, and Korean Patent Application No. 10-2023-0052834, filed on Apr. 21, 2023, in the Korean Intellectual Property Office, the disclosures of which are incorporated by reference herein in their entireties.

### BACKGROUND

### 1. Field

The disclosure relates to an electronic device that supports extended reality (XR) content and an input mode support method therefor.

### 2. Description of Related Art

With the development of communication technology and image processing technology, interest in services that provide a user with an extended reality (XR) experience is increasing.

XR or XR service may collectively refer to virtual reality (VR), augmented reality (AR), or mixed reality (MR), and may refer to a service in which a virtual environment or a virtual object that is virtually generated by an electronic device is independently provided to a user, or a real-world environment is provided together with the virtual object, so that the user may experience the virtual object or the virtual environment as if it were real.

An electronic device supporting XR content may be a wearable device of various types that are wearable on a body, and among them, a head-mounted display (HMD) device that is worn on a head or a face of a user is mainly used.

However, the HMD device is implemented to interact with a user by recognizing hand gestures such as pointing to or grabbing an object in XR content by a hand of the user through hand tracking, without using a separate input device such as a touch panel.

In addition, interaction through hand tracking may not only have a limitation in user convenience as it is difficult to use in a relatively small-sized space, but also have low input accuracy for a virtual object having a size smaller than a hand of the user.

Accordingly, in case of the HMD device, there is a need for a method of using a more intuitive input device such as a touch sensor to improve not only the input accuracy but also the immersion of the user.

### SUMMARY

According to an aspect of the disclosure, an electronic device includes: a body; a display provided at a first side of the body and facing a first direction toward a user of the electronic device; a touch sensor provided at a second side of the body and facing in a second direction opposite to the first direction; a plurality of first cameras provided at the second side of the body and facing in the second direction; at least one processor inside the body, and operatively connected to the display, the touch sensor, and the plurality of first cameras; and memory storing instructions, wherein the instructions, when executed by the at least one processor individually or collectively, to cause the electronic device to: control the display to output an extended reality (XR) content screen including at least one virtual object; based on identifying that a hand of the user is within a first distance from the touch sensor based on information obtained through at least one of the touch sensor or the plurality of first cameras, control the display to change the hand of the user displayed in the XR content screen to a virtual pointer object displayed in the XR content screen; based on a touch input being detected via the touch sensor, control the display to display a virtual area frame including the virtual pointer object in the XR content screen, the virtual area frame having a size corresponding to a touch sensor area of the touch sensor; and control motion of the virtual pointer object in the virtual area frame through a motion vector designated in correspondence to a touch input vector detected via the touch sensor.

The electronic device may be a head-mounted display device, and the XR content screen includes at least one screen providing a virtual reality (VR) service, and augmented reality (AR) service, or a mixed reality (MR) service.

The plurality of first cameras may include: a first functional camera configured to support at least one of head tracking, hand detection, hand tracking, or spatial recognition; a second functional camera configured to capture an outside environment and generate an image or video corresponding to the outside environment; and at least one of a depth sensor or depth camera configured to measure a distance between an external object and the electronic device, and the instructions, when executed by the at least one processor individually or collectively, cause the electronic device to: based on identifying that the hand of the user is positioned at a distance farther than the first distance from the touch sensor based on information obtained through at least one of the first functional camera and the depth sensor, display the XR content screen on the display in a first mode in which a hand-shaped object corresponding to the hand of the user is displayed in the XR content screen; based on identifying that the hand of the user is positioned within the first distance, display the XR content screen on the display in a second mode in which the hand-shaped object is changed to the virtual pointer object; and based on detection of a touch input via the touch sensor, displaying the XR content screen on the display in a third mode in which the virtual area frame is displayed in the XR content screen.

The instructions, when executed by the at least one processor individually or collectively, cause the electronic device to: determine a motion vector of a hand gesture based on switching to the second mode; and control the motion of the virtual pointer object by increasing a movement distance of the motion vector of the hand gesture by a set magnification ratio.

The instructions, when executed by the at least one processor individually or collectively, may cause the electronic device to: allocate the virtual area frame to at least a portion of the XR content screen when switching to the third mode; and restrict motion of the virtual pointer object to a space within the allocated virtual area frame.

The instructions, when executed by the at least one processor individually or collectively, may cause the electronic device to: display an entirety of the XR content screen in a plurality of grid areas having a N*M array of grid areas according to a plurality of settings based on switching to the second mode; and display a first grid area corresponding to a position of the virtual pointer object, among the plurality of grid areas, as a highlighted grid area.

The at least one virtual object may include a plurality of virtual objects, and the instructions, when executed by the at least one processor individually or collectively, may cause the electronic device to: display each of the plurality of virtual objects in different grid areas among the plurality of grid areas based on the plurality of virtual objects being present in the first grid area in the second mode.

The instructions, when executed by the at least one processor individually or collectively, may cause the electronic device to: change the size of the virtual area frame when a multi-touch gesture to expand or reduce the size of the virtual area frame is received, based on switching to the third mode; and change a motion vector value of the virtual object by a magnification ratio corresponding to the changed size of the virtual area frame.

The electronic device may further include: a second camera configured to track a gaze of the user and arranged in the first direction of the body, wherein the instructions, when executed by the at least one processor individually or collectively, may cause the electronic device to: track the gaze of the user via the second camera; and based on the hand of the use entering within the first distance spaced apart from the touch sensor, position the virtual pointer object at a central position of a direction of the tracked gaze of the user.

The instructions, when executed by the at least one processor individually or collectively, may cause the electronic device to display an inside of the virtual area frame as a grid having a N*M array of grid areas based on switching to the third mode.

The at least one virtual object may include a plurality of virtual objects, and the instructions, when executed by the at least one processor individually or collectively, may cause the electronic device to: based on the plurality of virtual objects being present in the virtual area frame in the third mode, enlarge a space of the virtual area frame by a ratio, to display the virtual area frame as overlapping at least a portion of the XR content screen.

The instructions, when executed by the at least one processor individually or collectively, may cause the electronic device to calibrate an error range for a touch input position detected by the touch sensor and a position of the virtual object output according to a gaze direction of the user.

According to an aspect of the disclosure, a method of an electronic device supporting XR content, the method including: outputting an extended reality (XR) content screen including at least one virtual object via a display of the electronic device; based on identifying that a hand of a user is within a first distance from a touch sensor of the electronic device based on information obtained through at least one of the touch sensor or a plurality of first cameras of the electronic device, controlling the display to change the hand of the user displayed in the XR content screen to a virtual pointer object displayed in the XR content screen; based on a touch input being detected via the touch sensor, controlling the display to display a virtual area frame including the virtual pointer object in the XR content screen, the virtual area frame having a size corresponding to a touch sensor area of the touch sensor; and controlling motion of the virtual pointer object in the virtual area frame through a motion vector designated in correspondence to a touch input vector detected via the touch sensor.

The displaying of the virtual pointer object further may include: tracking a gaze of the user via a second camera of the electronic device; and positioning the virtual pointer object at a central position of a direction of the tracked gaze of the user based on the hand of the user being within the first distance spaced apart from the touch sensor.

The outputting of the extended reality (XR) content screen to the display may further include: based on identifying that the hand of the user is positioned at a distance farther than the first distance from the touch sensor, displaying the XR content screen on the display in a first mode in which a hand-shaped object corresponding to the hand of the user is displayed in the XR content screen; based on the hand of the user entering within the first distance, to display the XR content screen on the display, displaying the XR content screen on the display in a second mode in which the hand-shaped object is changed to the virtual pointer object; and based on detection of a touch input via the touch sensor, displaying the XR content screen on the display in a third mode in which the virtual area frame is displayed in the XR content screen.

Various embodiments intend to provide a method in which the HMD device supports interaction of various input modes such as hovering input and touch input, in addition to interaction through hand tracking.

Provided are an electronic device and a method that may support providing an input guide user interface (UI)/user experience (UX) screen based on a user's hand position, by mounting a touch sensor on a side surface facing a display that is arranged on both eyes of a user.

Further, provided are an electronic device and a method that may provide an effect of enabling recognition of an input available area, by providing a guide for a hovering input and/or a guide for a touch input on an XR content screen, even if the touch sensor is not visible to actual eyes of a user.

Further, provided are an electronic device and a method that may improve touch input usability for a head-mounted display (HMD) device.

Further, provided are an electronic device and a method that may improve input error for a virtual object that exist at a far distance in the XR content, or has a small size.

Further, provided are an electronic device and a method that may reduce current consumption and improve touch concentration, through rendering for a portion to which a gaze of a user is directed, centered on a portion where touch input or hovering input is performed.

Additional aspects will be set forth in part in the description which follows and, in part, will be apparent from the description, or may be learned by practice of the presented embodiments.

According to an aspect of the disclosure, a non-transitory computer-readable recording media having recorded thereon a program that is executed by at least one processor of an electronic device to perform the aforementioned method.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of an electronic device in a network environment according to various embodiments;

FIG. 2 is a diagram schematically illustrating an appearance of a head-mounted display (HMD) device according to an embodiment;

FIGS. 3A to 3C are diagrams illustrating examples of an XR content screen that is displayed to a user of an HMD device according to a user's hand position according to an embodiment;

FIG. 4 illustrates an input mode support method of an electronic device supporting XR content according to an embodiment;

FIG. 5 illustrates another example of an XR content screen in a second mode that is displayed to a user when an HMD is worn, according to an embodiment; and

FIG. 6 illustrates another example of an XR content screen in a third mode that is displayed to a user when an HMD is worn, according to an embodiment.

### DETAILED DESCRIPTION

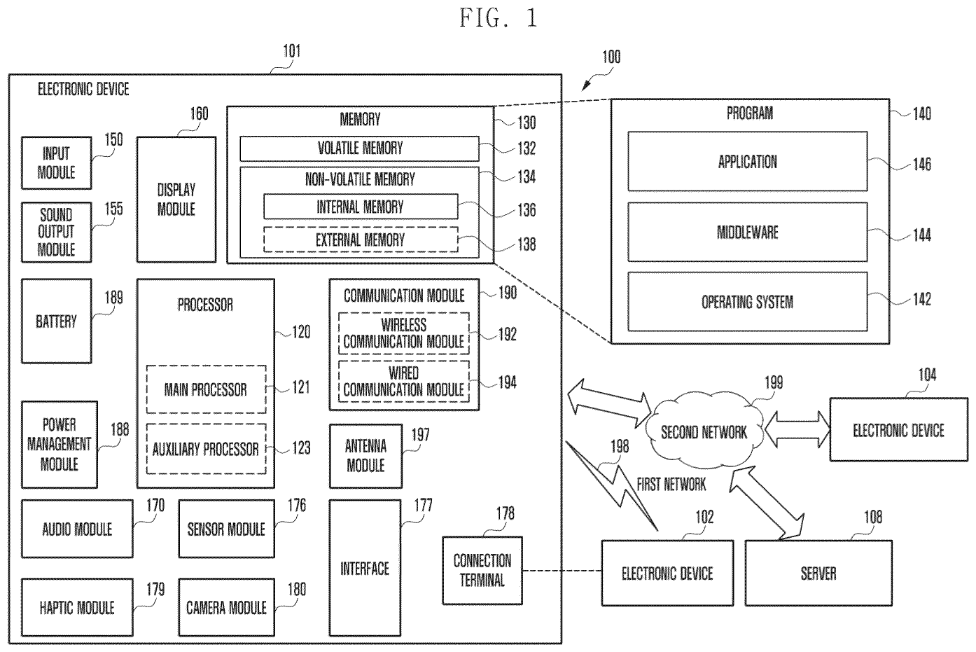

FIG. 1 is a block diagram illustrating an electronic device in a network environment according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, each of external electronic devices 102 and 104 may be a same or different type of device as the electronic device 101. According to an embodiment, all or some of operations executed in the electronic device 101 may be executed in one or more of the external electronic devices 102, 104, or 108. For example, when the electronic device 101 has to perform a function or service automatically or in response to a request from a user or another device, the electronic device 101 may request one or more external electronic devices to perform at least a part of the function or the service, instead of or in addition to executing the function or the service by itself. One or more external electronic devices that receive the request may execute at least a part of the requested function or service, or additional functions or services related to the request, and may deliver a result of the execution to the electronic device 101. The electronic device 101 may provide the result as-is, or after additionally processing the result, as at least a part of a response to the request.

For example, an external electronic device 102 may render content data executed by an application, and then deliver the content data to an electronic device 101, and the electronic device 101 that receives the data may output the content data to the display module 160. If the electronic device 101 senses a user's movement through a sensor, the processor 120 of the electronic device 101 may correct rendering data received from the external electronic device 102 based on movement information, and may output the corrected data to the display module 160. Alternatively, the processor 120 of the electronic device 101 may deliver movement information to the external electronic device 102 and may request rendering so that screen data is updated accordingly. According to an embodiment, the external electronic device 102 may be a device of various types, such as a case device for storing and charging a smartphone or the electronic device 101.

The electronic device according to an embodiment disclosed in this document may be a device of various types. The electronic device may include, for example, a portable communication device (e.g., a smartphone), a computer device, a portable multimedia device, a portable medical device, a camera, a wearable device, or a home appliance. The electronic device according to the embodiment of the present document is not limited to the above-mentioned devices.

Hereinafter, various embodiments will be described with reference to an example in which the electronic device 101 is a head-mounted display or head-mounted device (HMD).

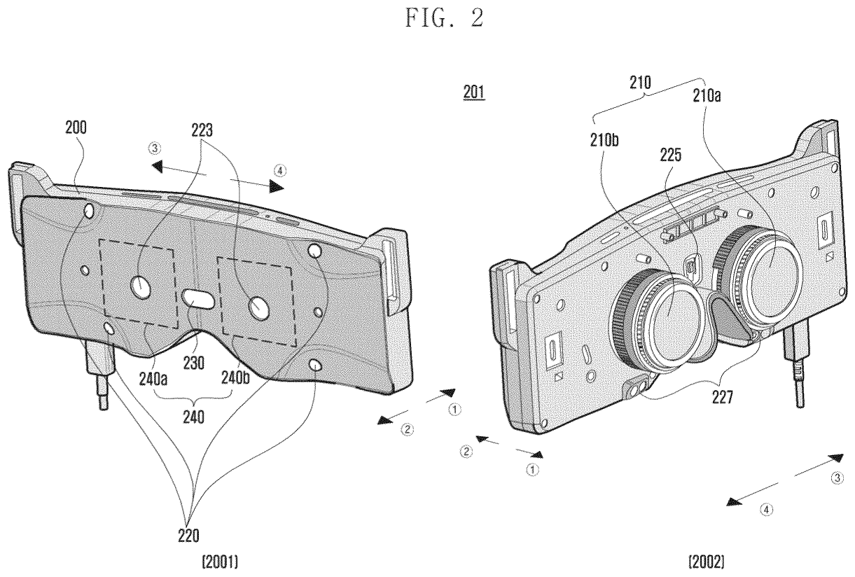

FIG. 2 schematically illustrates an external appearance of a head-mounted display (HMD) device according to an embodiment. 2001 in FIG. 2 may be an external appearance of a HMD device 201 viewed from a first direction (1), and 2002 may be an external appearance of the HMD device 201 viewed from a second direction (2). When a user wears the HMD device 201, an external appearance viewed by the user's eyes may be [2002].

With reference to FIG. 2, according to various embodiments, the electronic device 101 in FIG. 1 may include the HMD device 201 that provides a service for providing a user with an extended reality (XR) experience. For example, the XR or XR service may be defined as a service collectively referring to virtual reality (VR), augmented reality (AR), or mixed reality (MR).

According to an embodiment, the HMD device 201 may mean a head-mounted device or head-mounted display that is worn on a user's head part, but may also be configured in the form of at least one of glasses, goggles, helmet, or hat. The HMD device 201, when worn, may include an optical see-through (OST) type configured to allow external light to reach a user's eyes through glass, or a video see-through (VST) type configured to block external light from reaching the user's eyes, while allowing light emitted from a display to reach the user's eyes.

According to an embodiment, the HMD device 201 is worn on the user's head part and may provide an image related to an extended reality (XR) service to the user. For example, the HMD device 201 may provide XR content (hereinafter referred to as XR content image) that is output such that at least one virtual object appears to be overlapped in a display area or in an area determined as a field of view (FoV) of the user. According to an embodiment, the XR content may mean an image or video in which at least one virtual object is shown to be overlaid on an image related to a real space acquired through a camera (e.g., a shooting camera) or on a virtual space. According to an embodiment, the HMD device 201 may provide the XR content based on a function being performed by the HMD device 201, and/or a function being performed by at least one of the external electronic devices 102, 104, or 108.

According to an embodiment, the HMD device 201 may be at least partially controlled by an external electronic device (e.g., 102 or 104 in FIG. 1), and under the control of the external electronic device, at least one function may be performed, but at least one function may also be performed independently.

According to an embodiment, the HMD device 201 may include a body 200 that mounts at least a part of the configurations of FIG. 1, a display 210 (e.g., display module 160 in FIG. 1) arranged to face in a first direction \textcircled{1} of the body 200, a first functional camera 220 (e.g., recognition camera) arranged to face in a second direction \textcircled{2} of the body 200, a second functional camera 223 (e.g., shooting camera) arranged to face in the second direction \textcircled{2}, a third functional camera 225 (e.g., gaze tracking camera) arranged to face in the first direction 1, a fourth functional camera 227 (e.g., face recognition camera) arranged to face in the first direction \textcircled{1}, a depth sensor 230 arranged to face in the second direction \textcircled{2}, and a touch sensor 240 arranged to face in the second direction \textcircled{2}. The body 200 may include a memory (e.g., memory 130 in FIG. 1) and a processor (e.g., processor 120 in FIG. 1) therein, and may further include other configurations illustrated in FIG. 1.

According to an embodiment, the display 210 may include a liquid crystal display (LCD), a digital mirror device (DMD), a liquid crystal on silicon (LCoS), an organic light emitting diode (OLED), or a micro light emitting diode (micro LED).

In an embodiment, when the display 210 is formed of one of the liquid crystal display device (LCD), digital mirror display device (DMD), or liquid crystal on silicon display device (LCoS), the HMD device 201 may include a light source that emits light to a screen output area of the display 210. In another embodiment, when the display 210 may generate light by itself, for example, when the HMD device 201 is formed of one of the organic light emitting diode or micro LED, the HMD device 201 may provide high-quality XR content image to a user even without including a separate light source. In an embodiment, when the display 210 is implemented with the organic light emitting diode or the micro LED, the light source may be unnecessary, so the HMD device 201 may be lightweight.

According to an embodiment, the display 210 may include a first transparent member 210a and/or a second transparent member 210b. The user may use the HMD device 201 in a state of being worn on the face. The first transparent member 210a and/or the second transparent member 210b may be formed of a glass plate, plastic plate, or polymer, and may be manufactured to be transparent or semi-transparent. According to an embodiment, the first transparent member 210a may be arranged to face the user's right eye in the first direction \textcircled{1}, and the second transparent member 210b may be arranged to face the user's left eye in first direction \textcircled{1}. According to various embodiments, when the display 210 is transparent, it may be arranged at a position facing the user's eyes and may constitute a screen display area.

According to an embodiment, the display 210 may include a lens including a transparent waveguide. The lens may serve to adjust focus so that a screen (e.g., XR content image) output from the display may be shown to the user's eyes. For example, light emitted from the display panel may pass through the lens and may be delivered to the user through a waveguide formed in the lens. The lens may be composed of a Fresnel lens, a Pancake lens, or a multi-channel lens.

The waveguide (or optical waveguide) may serve to deliver a light source generated by the display to the user's eyes. The waveguide may be manufactured from glass, plastic, or polymer, and may include nano patterns formed on at least a partial surface of an inner or outer surface, for example, a grating structure having a polygonal or curved shape. According to an embodiment, light incident into one end of the waveguide may be propagated inside the display optical waveguide by the nano pattern and may be provided to the user. In addition, the waveguide composed of a free-form type of prism may provide the incident light to the user through a reflective mirror. The waveguide may include at least one of at least one diffractive element (e.g., diffractive optical element (DOE), holographic optical element (HOE)) or a reflective element (e.g., reflective mirror). The waveguide may guide display light emitted from a light source unit to the user's eyes by using at least one of the diffractive element or reflective element included in the waveguide.

According to an embodiment, the diffractive element may include an input optical member/output optical member. For example, the input optical member may mean an input grating area, and the output optical member may mean an output grating area. The input grating area may serve as an input end that diffracts (or reflects) light output from a light source unit (e.g., Micro LED) to deliver the light to a transparent member (e.g., first transparent member 210a, second transparent member 210b) of a screen display area. The output grating area may serve as an output that diffracts (or reflects) the light delivered to a transparent member (e.g., first transparent member, second transparent member) of the waveguide to the user's eyes.

According to an embodiment, the reflective element may include a total internal reflection (TIR) optical element for total internal reflection, or a total internal reflection waveguide. For example, total internal reflection may be one method for guiding light, and may mean forming an incident angle so that light (e.g., virtual image) input through the input grating area is substantially 100% reflected on one surface (e.g., a specific surface) of the waveguide, and substantially 100% delivered to the output grating area.

In an embodiment, light emitted from the display 210 may have an optical path guided to the waveguide through the input optical member. The light traveling inside the waveguide may be guided toward the user's eyes through the output optical member. The screen display area may be determined based on the light emitted in the direction of the eyes.

According to an embodiment, the HMD device 201 may include a plurality of cameras. For example, the cameras may include a first functional camera 220 (e.g., recognition camera) arranged to face in the second direction \textcircled{2} of the body 200, a second functional camera 223 (e.g., shooting camera) arranged to face in the second direction \textcircled{2}, a third functional camera 225 (e.g., gaze tracking camera) arranged to face in a first direction \textcircled{1}, and/or a fourth functional camera 227 (e.g., face recognition camera) arranged to face in the first direction \textcircled{1}, but may further include cameras for other functions not illustrated or described.

The first functional camera 220 (e.g., recognition camera) may be used for a purpose of sensing user's movement or a user gesture recognition function. The first functional camera 220 may support at least one of head tracking, hand detection, hand tracking, or spatial recognition. For example, in order to detect hand gestures and fine movement of fingers, and to track movement, the first functional camera 220 mainly uses a global shutter (GS) camera that has superior performance compared to a rolling shutter (RS) camera, and for head tracking and spatial recognition, may be configured as a stereo camera including two or more GS cameras. The first functional camera 220 may perform a simultaneous localization and mapping (SLAM) function for recognizing information (e.g., position and/or direction) related to the surrounding space through spatial recognition for 6 DoF and depth capturing.

The second functional camera 223 (e.g., shooting camera) may be used for a purpose of capturing the outside (e.g., an outside scene surrounding the user) and generating an image or video corresponding to the outside and delivering it to the processor 120. The processor 120 may display the image provided from the second functional camera 223 on the display 210. The second functional camera 223 may also be referred to as high resolution (HR) or photo video (PV), and may include a high-resolution camera. For example, the second functional camera 223 may include a color camera having functions for obtaining high-quality image, such as an auto focus (AF) function and vibration correction (optical image stabilizer (OIS)), but is not limited thereto, and the second functional camera 223 may also include a GS camera or an RS camera.

The third functional camera 225 (e.g., gaze tracking camera) may be arranged on the display 210 (or inside the body) such that the camera lens faces the user's eyes when the user wears the HMD device 201. The third functional camera 225 may be used for a purpose of detecting and tracking an pupil (eye tracking: ET). The processor 120 may track the movement of the user's left eye and right eye in an image received from the third functional camera 225, and may confirm a gaze direction. The processor 120 may allow the center of the XR content image displayed on the screen display area to be positioned according to a direction in which the pupil is gazing, by tracking the position of the pupil in the image. As one example, the third functional camera 225 may use a global shutter (GS) camera to detect a pupil and track the movement of the pupil. The third functional camera 225 may be respectively installed for the left eye and the right eye, and the performance and specification of each camera may be used as the same.

The fourth functional camera 227 (e.g., face recognition camera) may be used for a purpose of detecting and tracking a facial expression of the user (face tracking: FT) when the user wears the HMD device 201.

According to an embodiment, the HMD device 201 may include a lighting unit (e.g., LED) as an auxiliary means for the cameras. As one example, when tracking eye movement by the third functional camera 225, a lighting included in the display that directs emitted light (e.g., IR LEDs of infrared wavelengths) toward the user's both eyes may be used as an auxiliary means for facilitating gaze detection. As another example, the second functional camera 223 may further include a lighting unit (e.g., flash) as an auxiliary means for supplementing ambient brightness during external shooting.

According to an embodiment, the depth sensor 230 (or depth camera) may be used for a purpose of confirming a distance to an object (e.g., thing), such as time of flight (TOF). The time of flight (TOF) is a technology for measuring a distance to an object using a signal (e.g., near-infrared, ultrasound, or laser), in which a transmitting unit transmits a signal and then a receiving unit measures the signal, and the distance to the object may be measured based on the flight time of the signal.

According to an embodiment, the touch sensor 240 may be arranged to face in the second direction \textcircled{2} of the body 200. For example, when the user wears the HMD device 201, the user's eyes may look in the second direction \textcircled{2}. The touch sensor 240 may be implemented in a single type or in a left/right-separated type depending on the form of the body 200, but is not limited thereto. For example, in case where the touch sensor 240 is implemented in the left/right-separated type as illustrated in FIG. 2, when the user wears the HMD device 201, a first touch sensor 240a may be disposed a position corresponding to a user's right eye, and a second touch sensor 240b may be disposed at a position corresponding a user's left eye.

The touch sensor 240 may recognize a touch input by using at least one of, for example, a capacitive type, a pressure-sensitive type, an infrared type, or an ultrasonic type. As one example, the touch sensor 240 of the capacitive type may be capable of recognizing a physical touch (or contact) input of an external object, or a hovering input (or proximity). According to some embodiments, the HMD device 201 may use a proximity sensor to enable recognition of proximity of an external object.

According to an embodiment, the touch sensor 240 may have a two-dimensional surface, and may transmit touch data (e.g., touch coordinates) of an external object (e.g., user finger) contacting the touch sensor 240 to the processor 120. The touch sensor 240 may sense a hovering input of an external object (e.g., user finger) that approaches within a first distance spaced apart from the touch sensor 240, or may sense a touch input that touches the touch sensor 240.

According to an embodiment, when the external object touches the touch sensor 240, the touch sensor 240 may provide two-dimensional information regarding a contact point to the processor 120 as “touch data.” The touch data may be described as a “touch mode.” When the external object is positioned (or proximate, hovering above the touch sensor) within a first distance from the touch sensor 240, the touch sensor 240 may provide hovering data regarding a point in time or position of hovering around the touch sensor 240 to the processor 120. The hovering data may be described as a “hovering mode/proximity mode.”

According to an embodiment, the HMD device 201 may acquire the hovering data by using at least one of the touch sensor 240, the proximity sensor, and/or the depth sensor 230 to generate information regarding a spacing distance, position, or point in time between the touch sensor 240 and the external object.

According to an embodiment, an inside of the body 200 may include constituent elements of FIG. 1, for example, the processor 120 and the memory 130.

The memory 130 may store various instructions that may be performed by the processor 120. The instructions may include control commands, such as arithmetic and logical operations, data movement, or input/output, which may be recognized by the processor 120. The memory 130 may include a volatile memory (e.g., volatile memory 132 in FIG. 1) and a non-volatile memory (e.g., non-volatile memory 134 in FIG. 1) and may store various data temporarily or permanently.

The processor 120 may be configured to be operatively, functionally, and/or electrically connected to each constituent element of the HMD device 201, and may perform operations or data processing related to control and/or communication of each constituent element. The operations performed by the processor 120 may be executed by the instructions stored in the memory 130, which, when executed, cause the processor 120 to operate.

Hereinafter, although the operations and data processing functions that the processor 120 may implement on the HMD device 201 are not limited thereto, a series of operations related to an XR content service function will be described. The operations of the processor 120 to be described below may be performed by executing the instructions stored in the memory 130.

According to an embodiment, the processor 120 may generate a virtual object based on virtual information based on image information. The processor 120 may output the virtual object related to the XR service together with background space information through the display 210. For example, the processor 120 may capture an image related to a real space corresponding to a field of view of a user wearing the HMD device 201 through the second functional camera 223 to acquire image information, or may generate a virtual space for a virtual environment. For example, the processor 120 may control the display 210 to display XR content (hereinafter, referred to as XR content screen) that is output such that at least one virtual object appears to be overlapped in a display area or an area determined to be a field of view (FoV) of the user.

An electronic device according to an embodiment (e.g., electronic device 101 in FIG. 1, HMD device 201 in FIG. 2) may include a body (e.g., body 200 in FIG. 2), a display (e.g., display 210 in FIG. 2) arranged at a first side of the body 200 and facing in the first direction \textcircled{1}, a touch sensor (e.g., touch sensor 240 in FIG. 2) arranged at a second side of the body 200 opposite to the first side of the body 200 and facing in the second direction \textcircled{2} opposite to the first direction \textcircled{1}, first cameras (e.g., first functional camera 220, second functional camera 223) arranged at the second side of the body 200 and facing in the second direction \textcircled{2}, and a processor (e.g., processor 120 in FIG. 1) disposed inside the body 200 and operatively connected to the display 210, the touch sensor 240, and the first cameras (e.g., first functional camera 220, second functional camera 223), in which the processor 120 may be configured to: control the display 210 to output an extended reality (XR) content screen including at least one virtual object, and convert a user's hand displayed on the XR content screen into a virtual pointer object and display the virtual pointer object, based on information acquired from at least one of the touch sensor 240 and the first cameras (e.g., first functional camera 220, second functional camera 223), when a user's hand position enters within a first distance spaced apart from the touch sensor 240; control the display 210 to display a virtual area frame including the virtual pointer object and having a size corresponding to a touch sensor area of the touch sensor 240 in the XR content screen, based on detection of a touch input through the touch sensor 240; confirm a touch input vector detected through the touch sensor 240; and control motion of the virtual pointer object positioned in the virtual area frame through a motion vector designated in correspondence to the touch input vector.

The electronic device 101 according to an embodiment may include a head-mounted display device, and the XR content screen may include at least one of screens that provide a virtual reality (VR), augmented reality (AR), or mixed reality (MR) service.

The first cameras (e.g., first functional camera 220, second functional camera 223) according to an embodiment may include: a first functional camera 220 that supports at least one of head tracking, hand detection, hand tracking, or spatial recognition; a second functional camera 223 that captures the outside and generates an image or video corresponding to the outside; and at least one of a depth sensor (e.g., depth sensor 230 in FIG. 2) or a depth camera that measures a distance between an external object and the electronic device 101.

The processor 120 according to an embodiment may be configured to: display the XR content screen on the display 210 in a first mode that displays a hand shape corresponding to a recognized user's hand, when the user's hand is positioned at a distance farther than a first distance spaced apart from the touch sensor 240, through at least one of the first cameras (e.g., first functional camera 220, second functional camera 223); switch to a second mode that displays the user's hand shape in a form of a virtual pointer object, and display the XR content screen on the display 210, based on the user's hand entering within the first distance; and switch to a third mode that displays the virtual area frame to display the XR content screen on the display 210, based on detection of a touch input through the touch sensor 240.

The processor 120 according to an embodiment, when switching to the second mode, may be configured to calculate a motion vector of a hand gesture, and control motion of the virtual pointer object by increasing a movement distance of the motion vector of the hand gesture by a set magnification ratio.

The processor 120 according to an embodiment, when switching to the third mode, may be configured to allocate the virtual area frame to at least a portion of the XR content screen, and to restrict motion of the virtual pointer object only within a space of the allocated virtual area frame.

The processor 120 according to an embodiment, when switching to the second mode, may be further configured to divide and display an entirety of the XR content screen into a grid having an N*M array according to settings, and to display a first grid area corresponding to a position of the virtual pointer object, among the divided grid areas, as a highlighted grid area.

The processor 120 according to an embodiment, when a plurality of virtual objects are present in the first grid area in the second mode, may be configured to distribute and display each of the plurality of virtual objects into different grid areas.

The processor 120 according to an embodiment, when switching to the third mode, may be configured to change a size of the virtual area frame when a multi-touch gesture for expanding or reducing a size of the virtual area frame is received, and to change a motion vector value of the virtual object by a magnification ratio corresponding to the changed size of the virtual area frame.

The electronic device 101 according to an embodiment may include a second camera for gaze tracking (e.g., third functional camera 225 in FIG. 2) arranged at the first side of the body 200 and facing in the first direction \textcircled{1} of the body unit 200.

The processor 120 according to an embodiment may be configured to track a gaze of the user through the second camera (e.g., third functional camera 225 in FIG. 2), and when the user's hand enters within the first distance spaced apart from the touch sensor 240, to align a position of the virtual pointer at a central position of a direction of the tracked gaze of the user.

The processor 120 according to an embodiment, when switching to the third mode, may be further configured to divide and display the inside of the virtual area frame into a grid having an N*M array.

The processor 120 according to an embodiment, when a plurality of virtual objects are present in the virtual area frame in the third mode, may be further configured to enlarge a space of the virtual area frame by a ratio A to display the virtual area frame overlapping at least a portion of the XR content screen.

The processor 120 according to an embodiment may be further configured to calibrate an error range for a touch input position detected by the touch sensor 240 and a position of the virtual object output according to a gaze direction of the user.

According to an embodiment, when a surface of the touch sensor has a curved shape depending on the design of the body 200 of the HMD device 201, the processor 120 of the HMD device 201 may calculate a movement amount of a touch gesture by calculating a movement distance of the touch gesture based on a distance moved on a plane. For example, the HMD device 201 may store a curved surface value determined at the time of design configuration. The HMD device 201 may calculate a movement amount of a virtual pointer object matched 1:1 with the touch gesture, based on a movement distance of the touch gesture calculated using the curved surface value and a movement distance calculated based on a plane.

According to an embodiment, the HMD device 201 may also support a function of calibrating an error range for a touch input position and a position of the virtual pointer object according to a gaze direction of the user. According to an embodiment, the HMD device 201 may, as a preset function, output a plurality of guide objects that induce touch points on the XR content screen, thereby inducing touch contact at positions corresponding to the plurality of guide objects viewed by the user's gaze, and perform position correction by comparing position information between the positions where the touch contact is made and the guide objects displayed on the XR content screen.

According to various embodiments, the electronic device 101 may newly match the touch contact position with the corresponding position on the XR content screen, based on the touch contact position and the gaze direction information. This operation may minimize an error caused by a wearing state of the user or a shape of the head, and may reduce motion sickness by aligning a touch point with a virtual screen position of the gaze direction. Thereafter, the electronic device 101 may output a virtual pointer object at the corresponding position on the XR content screen upon sensing a touch, without using the gaze direction information.

In addition, according to various embodiments, the user gaze information may be used in various ways in combination with a touch contact input. For example, a position of the XR content screen may be designated through the gaze information, and a virtual object corresponding to the gaze direction position may be selected through the touch contact input.

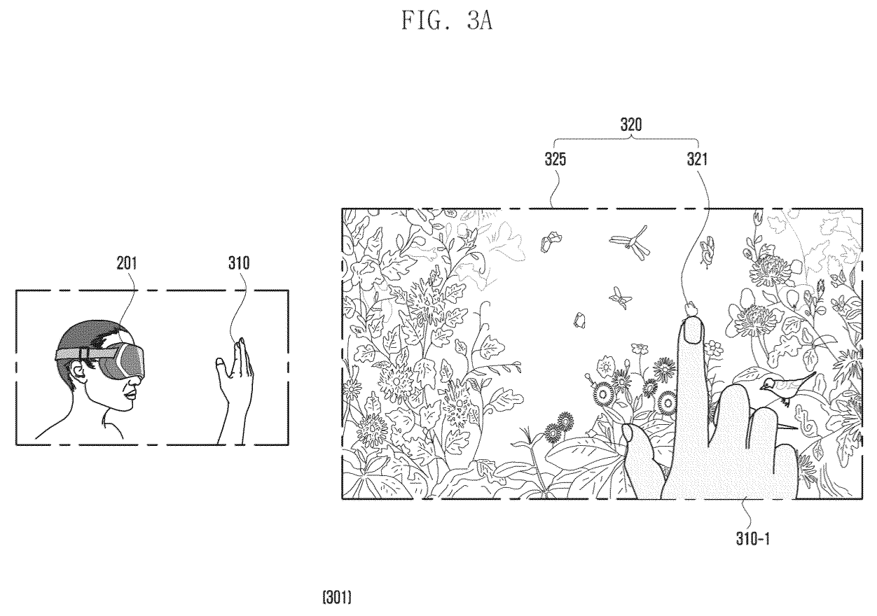

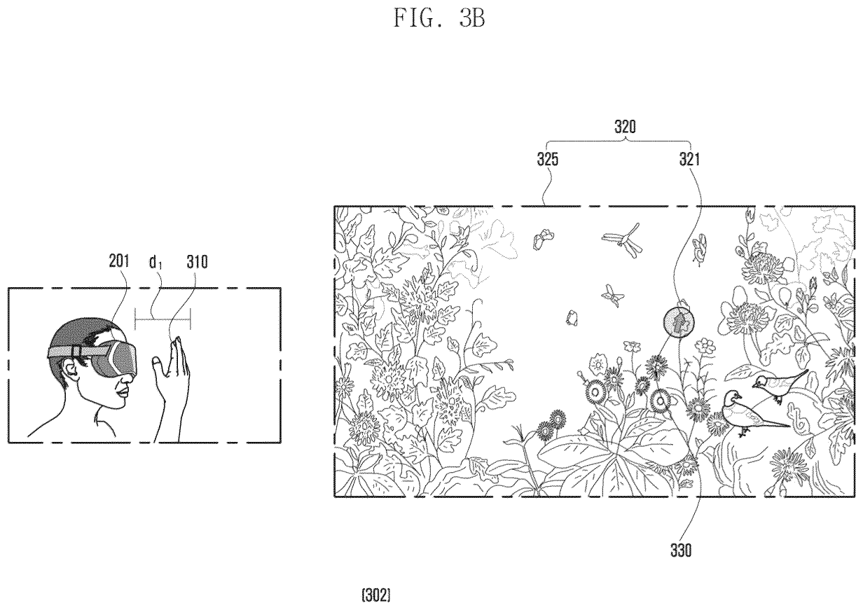

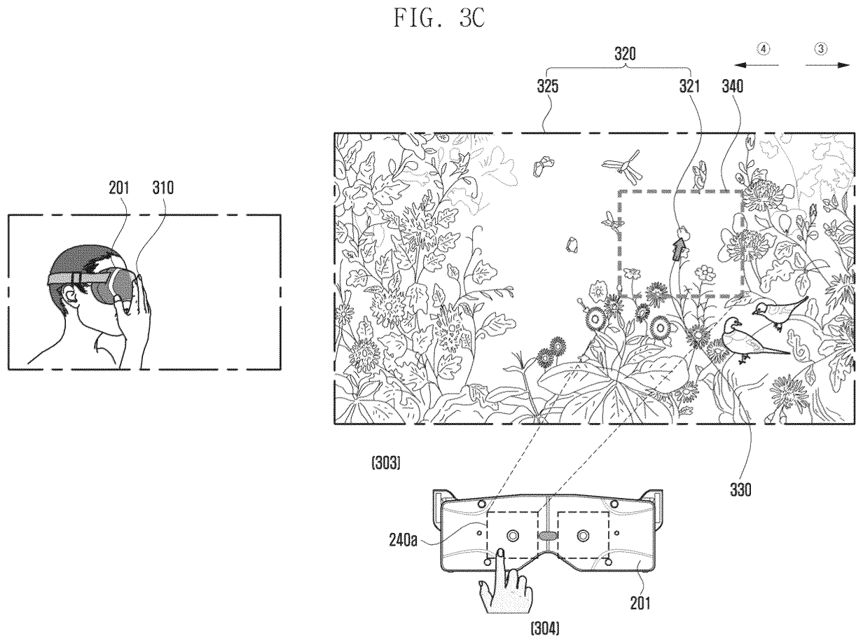

FIGS. 3A to 3C are diagrams illustrating examples of an XR content screen displayed to a user of an HMD device according to an embodiment.

With reference to FIGS. 3A to 3C, a HMD device according to an embodiment (e.g., electronic device 101 in FIG. 1, HMD device 201 in FIG. 2) may support providing input guide UI (user interface)/UX (user experience) screens of different modes according to a user's hand position. Hereinafter, the modes described in this document are terms used merely for distinguishing UI representations and for the convenience of description, and the HMD device 201 may not necessarily distinguish each mode independently or operationally. The HMD device 201 does not perform a series of operations or processes for switching from one mode to another mode operatively.

The HMD device 201 may output the XR content screen 320 through a display (e.g., display module 160 in FIG. 1, display 210 in FIG. 2), based on the HMD device 201 being worn on a part of a user's body. The display 210 of the HMD device 201 may be implemented as an OST type or VST type, depending on the form and properties of the display 210.

The XR content screen 320 may include at least one virtual object 321 in a background space 325 (e.g., real space or virtual space). For example, the HMD device 201 may configure the background space 325 as an area determined to be a field of view (FoV) of a user, based on a viewpoint of the user, and may generate the XR content screen 320 by rendering the virtual object 321 included in the area determined to be the field of view (FoV) of the user. The background space 325 may be a real image captured through a camera, depending on an XR service environment, or may be an image of a virtual environment.

The screen of FIG. 3A illustrates the XR content screen 320 in a first mode that is displayed to a user when a user's hand 310 is positioned beyond a first distance spaced apart from a touch sensor (e.g., touch sensor 240 in FIG. 2) (or the HMD device).

The HMD device 201 may recognize the user's hand 310 through hand tracking, and may determine whether the user's hand 310 exists at a position farther than the first distance spaced apart from the touch sensor, through the first functional camera 220 and/or the depth sensor 230. When the user's hand 310 exists at a position farther than the first distance, the HMD device 201 may output the XR content screen 320 in a first mode that displays a hand-shaped object 310-1 in correspondence to the user's hand 310 included in the field of view of the user, as illustrated in [301].

The first mode (e.g., normal mode/far mode) may mean a mode that displays the user's hand 310 recognized in a camera image as a hand shape, while a user is wearing the HMD device 201. The hand-shaped object 310-1 may be a user's hand that has been actually captured, or may be represented as a virtual hand object, depending on the XR service environment.

The screen of FIG. 3B illustrates the XR content screen 320 in a second mode that is displayed to a user when the user's hand 310 enters within a first distance d1 spaced apart from a touch sensor (e.g., touch sensor 240 in FIG. 2) or the HMD device 201. The HMD device 201 may determine whether the user's hand 310 enters within the first distance d1 spaced apart from the touch sensor 240 or the HMD device 201, based on at least one of the depth sensor 230 or the touch sensor 240. When the user's hand 310 enters within the first distance d1, the HMD device 201 may switch to and provide the XR content screen 320 in a second mode that displays a user's hand shape in the form of the virtual pointer object 330, as illustrated in [302].

The second mode (e.g., hovering mode/proximity mode) refers to a mode that, while a user is wearing the HMD device 201, divides and displays a form of the virtual pointer object 330 and/or an entirety of the background space, in correspondence to the user's hand 310 recognized in a camera image, into a grid.

In the second mode, the HMD device 201 may control motion of the virtual pointer object 330 with a movement amount having a higher magnification ratio than a movement amount that a hand gesture actually moves, such that a hovering input available area (i.e., an area that is executable with hovering input) of the hand gesture may cover an entire area of the XR content screen 320. For example, when it is detected that the user's hand 310, in a state of entering within the first distance, actually moves a distance of about 3 cm, the HMD device 201 may move the virtual pointer object 330 displayed in correspondence to the user's hand 310 by 3 cm*N ratio (e.g., 6 cm, 9 cm, 12 cm, etc.), so as to be implemented to cover an entire area of the background space 325 with a minimum movement. The N ratio may vary depending on settings.

The screen of FIG. 3C illustrates the XR content screen 320 in a third mode that is displayed to a user when the user's hand 310 directly touches or contacts a touch sensor (e.g., touch sensor 240 in FIG. 2). The HMD device 201, when the user's hand 310 touches or contacts the touch sensor, may align the position of a virtual pointer object 330 with the gaze direction of the user on an XR content screen 320, and may provide the XR content screen 320 by switching to a mode that displays a virtual area frame 340 based on the virtual pointer object 330 as illustrated in and [304]. For example, a user may touch or contact a first touch sensor 240a while wearing the HMD device 201 and gazing to the right side of the XR content screen (e.g., third direction \textcircled{3} in FIG. 2). Since the external appearance of is an external appearance viewed from a second direction (e.g., second direction \textcircled{2} in FIG. 2) in a state in which the user is worn, the first touch sensor 240a may be at a position arranged on the user's right eye. The HMD device 201, as the user touches the first touch sensor 240a while looking toward the right side, such as the third direction \textcircled{3}, may display a virtual area frame 340 corresponding to the size of the first touch sensor 240a in a partial area in the third direction \textcircled{3} of the XR content screen 320, based on the central point of the gaze direction. In contrast, when the user wears the HMD device 201, and touches or contacts the second touch sensor 240b while looking toward the left side, such as a fourth direction (e.g., fourth direction \textcircled{4} in FIG. 2), a virtual area frame 340 corresponding to the size of the second touch sensor 240b may be displayed in a partial area in the fourth direction \textcircled{4} of the XR content screen 320. According to an embodiment, the position at which the virtual area frame 340 is displayed in the XR content screen 320 may vary depending on the user's gaze position.

The third mode (e.g., touch mode) may refer to a mode that divides and displays the virtual area frame 340 indicating a touch available area (i.e., an area executable by touch input) and/or the inside of the virtual area frame 340 into a grid. The virtual area frame 340 may be allocated in the XR content screen 320 in a size substantially matched 1:1 with the size of the touch sensor 240. In the third mode, the HMD device 201 may control motion of the virtual pointer object 330 to be substantially the same as the movement amount of the touch gesture. For example, the processor 120, when the user's hand 310 drags about 1 cm after making a touch contact, may move and display the virtual pointer object 330 by 1 cm in the XR content screen.

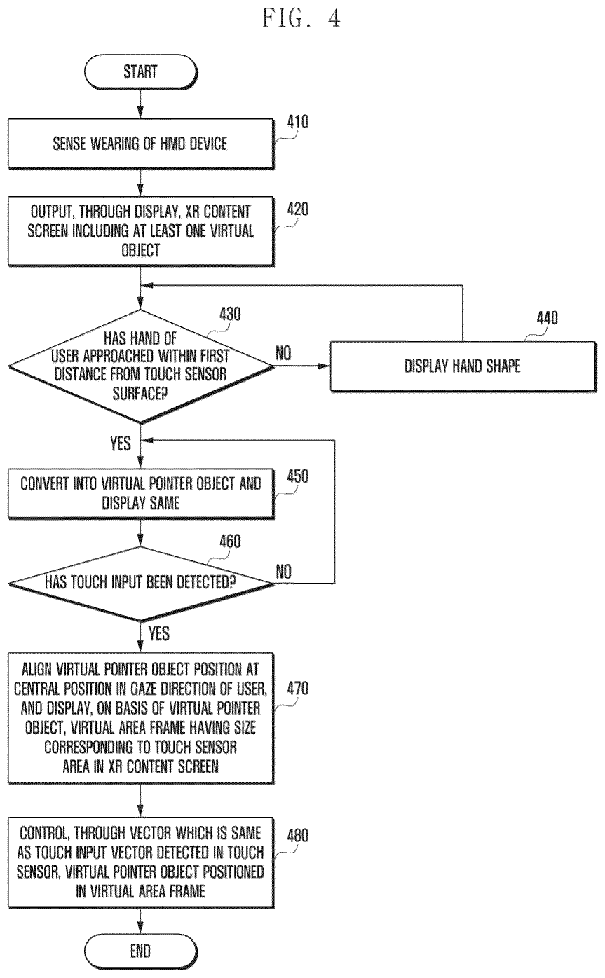

FIG. 4 illustrates an input mode support method of an electronic device supporting XR content according to an embodiment.

In embodiments below, each operation may be performed sequentially, but is not required to be performed sequentially. For example, the order of each operation may be changed, and at least two operations may be performed in parallel.

With reference to FIG. 4, in operation 410, a processor (e.g., processor 120 in FIG. 1) of the electronic device 101 or HMD device 201 according to an embodiment may sense that the HMD device 201 is being worn.

For example, the processor 120 may sense whether the HMD device 201 is worn on the user's body (e.g., wear sensing or removal sensing) based on sensor information acquired through a sensor (e.g., a wear sensing sensor).

In operation 420, the processor 120, based on the HMD device 201 being worn on a part of the user's body, may output an XR content screen 320 including at least one virtual object 321 in a background space 325 (e.g., real space or virtual space) corresponding to the user's field of view to a display (e.g., display module 160 in FIG. 1, display 210 in FIG. 2).

In operation 430, the processor 120 may determine whether the user's hand 310 enters within a first distance d1 from the HMD device 201 or the touch sensor 240.

For example, the processor 120 may detect an external object (e.g., a user's hand) present in the user's field of view based on images captured through cameras (e.g., first functional camera 220 and/or second functional camera 223 in FIG. 2) facing in a second direction (e.g., second direction (2 in FIG. 2). The processor 120 may determine the movement direction and position of the user's hand 310 through hand tracking.

In operation 440, when the user's hand 310 is positioned at a distance farther than the first distance d1 from the touch sensor 240 or the HMD device 201, the processor 120 may provide the XR content screen 320 in a first mode, in which a hand shape is displayed corresponding to the user's hand recognized in the user's field of view.

For example, the processor 120 may measure a spaced distance between the user's hand 310 and the touch sensor 240 (or the HMD device) through a depth sensor (e.g., depth sensor 230 in FIG. 2).

In the first mode (e.g., normal mode/far mode), the processor 120 may recognize interaction with a virtual object 321 based on the movement direction and position of the user's hand 310. As an example, the HMD device 201 may determine that an interaction is performed on the virtual object 321, based on the user's hand 310 overlapping the position where the virtual object 321 is displayed and a gesture for grabbing (or grab gesture) the virtual object 321 being recognized.

In operation 450, when it is recognized that the user's hand 310 enters within the first distance d1 from the touch sensor 240 or the HMD device 201, or when the user's hand 310 enters from a distance farther than the first distance d1 within the first distance d1, the processor 120 may switch to a second mode that displays a virtual pointer object 330 corresponding to the position of the user's hand 310 instead of displaying the hand shape, to provide the XR content screen 320. The virtual pointer object 330 may have various sizes and shapes according to settings and is not limited thereto.

According to an embodiment, the processor 120 may determine whether a distance between the user's hand 310 and the touch sensor 240 enters within the first distance d1, based on at least one of the first functional camera 220, the depth sensor 230, and/or the touch sensor 240. For example, the processor 120, while measuring the distance from the user's hand 310 using the depth sensor 230, may, when the user's hand 310 enters within a proximity sensing distance (or hovering sensing distance) of the touch sensor 240, ignore the depth sensor value and measure the distance between the user's hand 310 and the touch sensor 240 using the sensing value of the touch sensor 240.

When the user's hand 310 exists at a position outside the first distance d1, an activity area of a hand movement may cover the entire area of the background space 325 existing in the user's field of view, but, when the user's hand 310 enters within the first distance d1, the activity area of the hand movement becomes relatively narrower, and it may be difficult to cover the entire area of the background space 325 in a one-to-one matching manner with the hand movement.

In the second mode (e.g., hovering mode/proximity mode), the processor 120 may calculate a motion vector of the hand gesture recognized by hand tracking, and may increase the motion vector of the hand gesture by a magnification ratio of N (e.g., N>2) to control the motion of the virtual pointer object 330. For example, assuming that the user's hand 310, in a state of entering within the first distance, has actually moved about 3 cm, the HMD device 201 may be implemented to move the virtual pointer displayed in correspondence to the user's hand 310 by a predetermined ratio such as 3 cm*N magnification ratio (e.g., 6 cm), thereby covering the entire area of the background space 325 with minimal movement.

In operation 460, the processor 120 may determine whether a touch input directly contacting the touch sensor 240 is detected.

In operation 470, the processor 120, in response to the touch input being detected, may align the position of the virtual pointer object 330 at the central position of the gaze direction of the user, and may provide the XR content screen 320 by switching to a third mode (e.g., touch mode) that displays the virtual area frame 340 having a size corresponding to the touch sensor area, including the virtual pointer object 330, on the XR content screen.

When switching to the third mode, the processor 120 may detect a touch position detected through the touch sensor 240. The touch position may include two-dimensional coordinate data (e.g., x-axis and y-axis coordinate information).

The processor 120 may detect a gaze direction of the user measured from the second direction of the HMD device 201. For example, the processor 120 may recognize an object corresponding to a pupil from an image acquired through a third functional camera (e.g., a gaze tracking camera) facing in the first direction (e.g., first direction \textcircled{1} in FIG. 2), and may confirm a gaze direction that the pupil is looking at by tracking a movement of the pupil.

The processor 120 may align a position of the virtual pointer object 330 at a central position of the gaze direction. The processor 120 may allocate coordinates (e.g., x, y) of a point touched at the position of the virtual pointer object, and may allocate the virtual area frame 340 having a size substantially matched 1:1 to the size of the touch sensor by applying the stored size of the touch sensor based on the corresponding position to the XR content screen 320. The virtual area frame 340 may include the virtual pointer object 330, and may be allocated in the size of the touch sensor 240. In this case, a motion vector of the virtual pointer object may be set to (0, 0). For example, when a touch point (e.g., x, y) is moved to (x−1, y−1) by a touch movement, the processor 120 may assume that the virtual pointer object also moves from (0, 0) to (−1, −1) identically. As another example, when the magnification ratio of the motion vector is *2, the virtual pointer object may move from (0, 0) to (−2, −2). The processor 120 may move a virtual pointer object positioned on the XR content screen with a motion vector designated in correspondence to a touch input vector.

According to an embodiment, the virtual area frame 340 may vary depending on a size of the touch sensor 240 mounted on the HMD device 201. For example, when the touch sensor 240 has a single rectangular size, the virtual area frame 340 may have a single rectangular size. As another example, when the touch sensor 240 is mounted as a first touch sensor (e.g., first touch sensor 240a in FIG. 2) and a second touch sensor (e.g., second touch sensor 240b in FIG. 2) in a square shape in correspondence to both left and right eyes, the virtual area frame 340 may have a square size. For example, when the user touches the first touch sensor 240a while wearing the HMD device 201, a virtual area frame of a square size corresponding to the first touch sensor 240a may be displayed, and when the user touches the second touch sensor 240b, a virtual area frame of a square size corresponding to the second touch sensor 240b may be displayed.

The HMD device 201 may guide a touch available area (e.g., virtual area frame 340) that is touchable on the XR content screen 320 to the user, based on detection of a touch input, thereby providing an effect that allows the user to recognize the touch available area through the virtual area frame 340, even though the touch sensor 240 is not visually perceivable while the HMD device 201 is being worn.

According to an embodiment, when entering the third mode, the processor 120 may receive a multi-touch input (e.g., pinch-out gesture, pinch-in gesture, or double tap) through the touch sensor 240, and may execute a function of enlarging or reducing a touch magnification ratio in correspondence to the multi-touch input. For example, the processor 120 may display, on the XR content screen, the virtual area frame 340 of a first size designated as a size matched 1:1 with the touch sensor 240, based on detection of a touch input. When a pinch-out gesture or a multi-touch gesture designated to expand the virtual area frame is received through the touch sensor 240 in a state where the virtual area frame 340 of the first size is displayed, the processor 120 may enlarge the virtual area frame to a second size, and may adjust a motion vector value (e.g., a magnification ratio of 2, 3, 4, or N) of the virtual object corresponding to the second size. For example, a virtual object moved in the virtual area frame of the first size may move with the same vector as the touch input vector, whereas a virtual object moved in the virtual area frame of the second size may move with a motion vector with a magnification ratio of 2 of the touch input vector. In another example, when a pinch-in gesture or a multi-touch gesture designated to reduce the virtual area frame is received while the virtual area frame of the second size is being displayed, the processor 120 may reduce the virtual area frame back to the first size, and may change the motion vector value of the virtual object to correspond to the first size.

According to an embodiment, the magnification ratio of the motion vector of the virtual object corresponding to the enlargement or reduction of the virtual area frame may be preset in advance or may be changeable according to user settings.

In operation 480, the processor 120 may control a virtual pointer object positioned in the virtual area frame 340 through a motion vector designated in correspondence to a touch input vector detected in the touch sensor 240.

The processor 120 may confirm a touch input vector received through a user gesture, and may move the virtual pointer object 330 present in the virtual area frame 340 with a motion vector designated in correspondence with the touch input vector. The designated motion vector may be a vector of the same magnitude as the touch input vector, or may be set to a motion vector having a magnification ratio smaller than the magnification ratio set in the second mode.

For example, when a drag movement of about 1 cm is sensed after a touch contact, the processor 120 may control the virtual pointer object in the XR content screen to move by 1 cm, which is the same as the touch input vector.

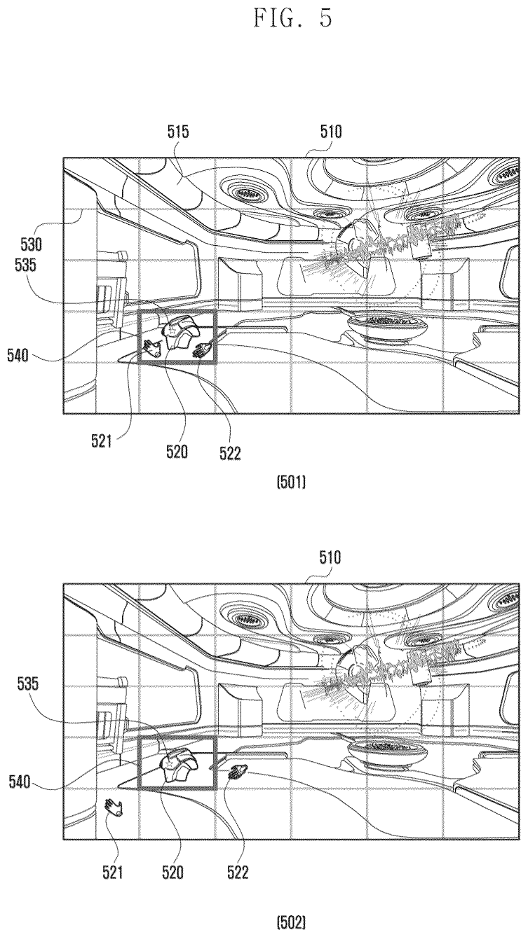

FIG. 5 illustrates another example of an XR content screen in the second mode displayed to a user when a HMD is worn, according to an embodiment.

With reference to FIG. 5, according to an embodiment, the HMD device 201 may support not only a function of converting a user's hand shape into a form of a virtual pointer object when switching to the second mode, but also a function of dividing and displaying an entirety of the background space of the XR content screen 510 into a grid having an N*M array according to settings, in order to guide a proximity input area or hovering input area based on a hand gesture.

As illustrated in <501>, the HMD device 201 may provide, through a display, the XR content screen 510 including a first virtual object 520, a second virtual object 521, and a third virtual object 522 in a background space 515.

According to an embodiment, in the second mode, the HMD device 201 may track a user gaze direction, display a virtual pointer object 535 aligned according to a hand gesture position and the user gaze direction, and provide a UI that displays a first grid area 540 corresponding to a position of a virtual pointer object as a highlight, among the divided grid areas 530.

According to an embodiment, the virtual pointer object 535 may be provided in various symbols or images according to settings. The size and shape of the grid area 530 may also be provided in various forms according to settings.

According to an embodiment, in the second mode, when the user's hand is in a close state within the first distance, and the user's hand moves to a different position, the HMD device 201 may move the highlight display to a different grid area according to the user's hand position, thereby providing an input guide as to which position the user's hand is positioned in on the XR content screen 510.

According to an embodiment, in the second mode, when a plurality of virtual objects are present in the first grid area 540 where the user's hand is positioned, the HMD device 201 may distribute and display the plurality of virtual objects to surrounding different grid areas, as illustrated in <502>. For example, the HMD device 201 may leave the first virtual object 520, which is present closest to a central position of the user's gaze, in the highlighted first grid area, move and output the third virtual object 522 to a different grid area on the right, and move and output the second virtual object 521 to a different grid area on the left. The HMD device 201 may improve the accuracy of hovering input for the virtual objects through the displayed virtual objects in a distributed manner.

According to an embodiment, the HMD device 201 may store position information for each virtual object before the distributed display of the virtual objects, and when one of the virtual objects is selected after the distributed display of the objects, the HMD device 201 may restore the virtual objects to be displayed at their original positions based on the position information of each displayed virtual object in a distributed manner.

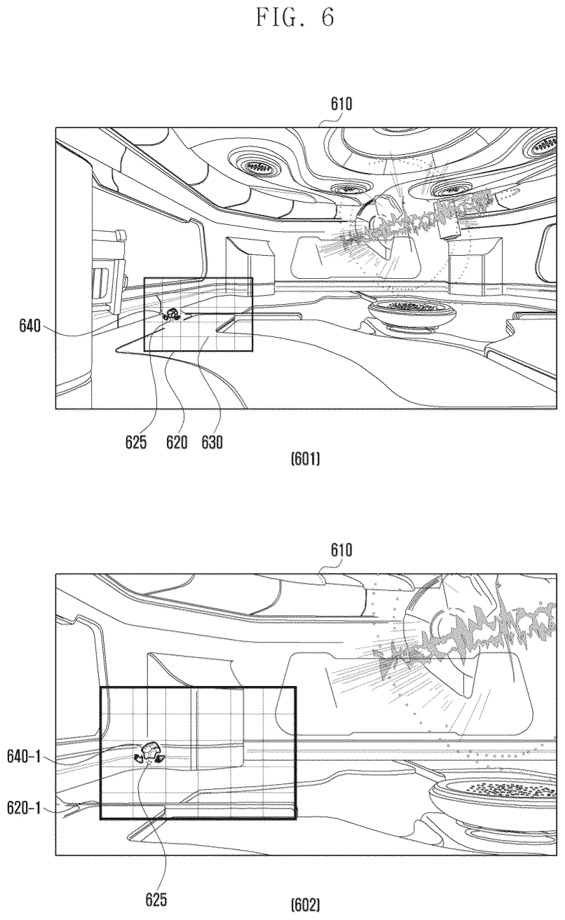

FIG. 6 illustrates another example of an XR content screen in a third mode that is displayed to a user when an HMD is worn, according to an embodiment.

With reference to FIG. 6, the HMD device 201 according to an embodiment may, when switching to the third mode, support not only a function of allocating a virtual area frame 620 in the XR content screen 610 in correspondence to the size of the touch sensor and displaying a virtual pointer object 625, but also a function of dividing and displaying the inside of the virtual area frame 620 into a grid having an N*M array in order to guide a touch input area.

As illustrated in <601>, in the third mode, the HMD device 201 may divide and display the virtual area frame 620 in the XR content screen 610 into a grid having an N*M array. The HMD device 201 may display the virtual pointer object 625 at a position aligned according to the user gaze direction and the touch point among the grid areas divided in the virtual area frame 620, or may display the grid area corresponding to the touch point with a highlight pattern, thereby providing a touch guide to the user and improving the touch accuracy of the user.

According to an embodiment, when a plurality of virtual objects are present in the virtual area frame 620, the HMD device 201, as illustrated in <602>, may enlarge only a space corresponding to the virtual area frame 620 by a ratio A and provide it in an overlapping manner on the XR content screen 610.

According to an embodiment, an input mode support method of an electronic device supporting XR content (e.g., electronic device 101 in FIG. 1, HMD device 201 in FIG. 2) may include: outputting an extended reality (XR) content screen including at least one virtual object to a display (e.g., display 210 in FIG. 2); converting a user's hand displayed on the XR content screen into a virtual pointer object and displaying the virtual pointer object, when a user's hand position enters within a first distance spaced apart from a touch sensor 240, based on information acquired from at least one of the touch sensor (e.g., touch sensor 240 in FIG. 2) and first cameras (e.g., first functional camera 220, second functional camera 223); displaying a virtual area frame, which includes the virtual pointer object and has a size corresponding to a touch sensor area of the touch sensor 240 in the XR content screen, based on a detection of a touch input through the touch sensor 240; and confirming a touch input vector detected through the touch sensor 240 and controlling motion of the virtual pointer object positioned in the virtual area frame with a vector designated in correspondence to the touch input vector.

According to an embodiment, the displaying of the virtual pointer object may further include: tracking a gaze of the user through a second camera for gaze tracking (e.g., third functional camera 225 in FIG. 2); and aligning a position of the virtual pointer at a central position of a direction of the tracked gaze of the user when the user's hand enters within the first distance spaced apart from the touch sensor 240.

According to an embodiment, the first cameras (e.g., first functional camera 220, second functional camera 223) may include at least one of: a first functional camera 220 that supports at least one of head tracking, hand detection, hand tracking, or spatial recognition; a second functional camera 223 that captures the outside and generates an image or video corresponding to the outside; or a depth sensor or depth camera (e.g., depth sensor 230 in FIG. 2) that measures a distance between an external object and the electronic device.

According to an embodiment, the outputting of the extended reality (XR) content screen to the display 210 may further include: displaying the XR content screen to the display 210 in a first mode that displays a hand shape in correspondence to the recognized user's hand when the user's hand is positioned at a distance farther than the first distance spaced apart from the touch sensor 240; switching to a second mode that displays the user's hand shape in a form of the virtual pointer object, to display the XR content screen to the display 210, based on the user's hand entering within the first distance; and switching to a third mode that displays the virtual area frame based on detection of a touch input through the touch sensor 240, to display the XR content screen to the display 210.

According to an embodiment, the switching to the second mode to display the XR content screen on the display 210 may further include: calculating a motion vector of a hand gesture; and controlling motion of the virtual pointer object by increasing a movement distance of the motion vector of the hand gesture by a set magnification ratio.

According to an embodiment, the input mode support method may further include: after the displaying of the virtual area frame having a size corresponding to the touch sensor area of the touch sensor 240, when a multi-touch gesture for expanding or reducing a size of the virtual area frame is received, changing the size of the virtual area frame, and changing a motion vector value of the virtual object by a magnification ratio corresponding to the changed size of the virtual area frame.

According to an embodiment, the switching to the second mode to display the XR content screen on the display 210 may include: dividing and displaying an entirety of the XR content screen into a grid having an N*M array according to settings; and displaying, among the divided grid areas, a first grid area corresponding to a position of the virtual pointer object as a highlight.

According to an embodiment, the switching to the third mode to display the XR content screen on the display 210 may include: dividing and displaying an inside of the virtual area frame into a grid having an N*M array. Various embodiments of the present document and the terms used in the embodiments are not intended to limit the technical features disclosed in the present document to the particular embodiments and should be understood as including various alterations, equivalents, or alternatives of the corresponding embodiments. In connection with the description of the drawings, the similar reference numerals may be used for the similar or relevant constituent elements. The singular form of a noun corresponding to an item may include one or plurality of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Such terms as “1st” and “2nd,” or “first” and “second” may be used to simply distinguish a corresponding constituent element from another, and does not limit the constituent elements in other aspect (e.g., importance or order). When a constituent element (e.g., a first constituent element) is referred to, with or without the term “operatively” or “communicatively,” as “coupled with,” “coupled to,” “connected with,” or “connected to” another constituent element (e.g., a second constituent element), it means that the constituent element may be coupled with the other constituent element directly (e.g., wiredly), wirelessly, or via a third constituent element.

The term “module” used in the embodiments of the present document may include a unit implemented in hardware, software, or firmware, and may interchangeably be used with other terms, for example, “logic,” “logic block,” “part,” or “circuitry”. The module may be a single integral component, or a minimum unit or part thereof, adapted to perform one or more functions. For example, according to an embodiment, the module may be implemented in a form of an application-specific integrated circuit (ASIC).

The embodiments as set forth herein may be implemented as software (e.g., program 140) including one or more instructions that are stored in a storage medium (e.g., internal memory 136 or external memory 138) that is readable by a machine (e.g., electronic device 101). For example, the processor (e.g., processor 120) of the device (e.g., electronic device 101) may invoke and execute at least one of one or more instructions stored from the storage medium. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Here, “non-transitory” only means that the storage medium is a tangible device and does not include signals (e.g., electromagnetic waves), and this term does not distinguish between the case where the data is stored on the storage medium permanently and the case where the data is stored temporarily.

According to an embodiment, the methods according to the embodiments disclosed in this document may be included in and provided as a computer program product. The computer program product may be traded as a product between a seller and a buyer. The computer program product may be distributed in the form of a device-readable storage medium (e.g., compact disc read only memory (CD-ROM)), or it may be distributed online (e.g., downloaded or uploaded) through an application store (e.g., Play Store™) or directly between two user devices (e.g., smartphones). In case of the distribution online, at least part of the computer program product may be temporarily generated or at least temporarily stored in the machine-readable storage medium, such as memory of the manufacturer's server, a server of the application store, or a relay server.

According to the embodiments, each constituent element (e.g., module or program), among the above-mentioned constituent elements, may include a single object or a plurality of objects, and some of the plurality of objects may be disposed separately in different constituent elements. According to the embodiments, one or more constituent elements, among the above-mentioned constituent elements, or operations may be omitted, or one or more other constituent elements or operations may be added. Alternatively or additionally, a plurality of constituent elements (e.g., modules or programs) may be integrated into a single constituent element. In this case, the integrated constituent element may perform one or more functions of each of the plurality of constituent elements in the same or similar manner as they are performed by a corresponding one of the plurality of constituent elements before the integration. According to the embodiments, operations performed by the module, the program, or another constituent element may be carried out sequentially, in parallel, repeatedly, or heuristically, or one or more of the operations may be executed in a different order or omitted, or one or more other operations may be added.

What is claimed is:

1. An electronic device comprising:
a body;
a display provided at a first side of the body and facing a first direction toward a user of the electronic device;
a touch sensor provided at a second side of the body and facing in a second direction opposite to the first direction of the body;
a plurality of first cameras provided at the second side of the body and facing the second direction;
at least one processor inside the body, and operatively connected to the display, the touch sensor, and the plurality of first cameras; and
memory storing instructions,
wherein the instructions, when executed by the processor individually or collectively, to cause the electronic device to:
control the display to output an extended reality (XR) content screen including at least one virtual object;
based on identifying that a hand of the user is within a first distance from the touch sensor based on information obtained through at least one of the touch sensor or the plurality of first cameras, control the display to change the hand of the user displayed in the XR content screen to a virtual pointer object displayed in the XR content screen;
based on a touch input being detected via the touch sensor, control the display to display a virtual area frame including the virtual pointer object in the XR content screen, the virtual area frame having a size corresponding to a touch sensor area of the touch sensor; and
control motion of the virtual pointer object in the virtual area frame through a motion vector designated in correspondence to a touch input vector detected via the touch sensor.

2. The electronic device of claim 1, wherein the electronic device is a head-mounted display device, and
wherein the XR content screen comprises at least one screen providing a virtual reality (VR) service, and augmented reality (AR) service, or a mixed reality (MR) service.

3. The electronic device of claim 1, wherein the plurality of first cameras comprises:
a first functional camera configured to support at least one of head tracking, hand detection, hand tracking, or spatial recognition;
a second functional camera configured to capture an outside environment and generate an image or video corresponding to the outside environment; and
at least one of a depth sensor or depth camera configured to measure a distance between an external object and the electronic device, and
wherein the instructions, when executed by the at least one processor individually or collectively, cause the electronic device to:
based on identifying that the hand of the user is positioned at a distance farther than the first distance from the touch sensor based on information obtained through at least one of the first functional camera and the depth sensor, display the XR content screen on the display in a first mode in which a hand-shaped object corresponding to the hand of the user is displayed in the XR content screen;
based on identifying that the hand of the user is positioned within the first distance, display the XR content screen on the display in a second mode in which the hand-shaped object is changed to the virtual pointer object; and
based on detection of a touch input via the touch sensor, displaying the XR content screen on the display in a third mode in which the virtual area frame is displayed in the XR content screen.

4. The electronic device of claim 3, wherein the instructions, when executed by the at least one processor individually or collectively, cause the electronic device to:
determine a motion vector of a hand gesture based on switching to the second mode; and
control the motion of the virtual pointer object by increasing a movement distance of the motion vector of the hand gesture by a set magnification ratio.

5. The electronic device of claim 3, wherein the instructions, when executed by the at least one processor individually or collectively, cause the electronic device to:
allocate the virtual area frame to at least a portion of the XR content screen when switching to the third mode; and
restrict motion of the virtual pointer object to a space within the allocated virtual area frame.

6. The electronic device of claim 3, wherein the instructions, when executed by the at least one processor individually or collectively, cause the electronic device to:
display an entirety of the XR content screen in a plurality of grid areas having a N*M array of grid areas according to a plurality of settings based on switching to the second mode; and
display a first grid area corresponding to a position of the virtual pointer object, among the plurality of grid areas, as a highlighted grid area.

7. The electronic device of claim 6, wherein the at least one virtual object comprises a plurality of virtual objects, and
the instructions, when executed by the at least one processor individually or collectively, cause the electronic device to:
display each of the plurality of virtual objects in different grid areas among the plurality of grid areas based on the plurality of virtual objects being present in the first grid area in the second mode.

8. The electronic device of claim 3, wherein the instructions, when executed by the at least one processor individually or collectively, cause the electronic device to:
change the size of the virtual area frame when a multi-touch gesture to expand or reduce the size of the virtual area frame is received, based on switching to the third mode; and
change a motion vector value of the virtual object by a magnification ratio corresponding to the changed size of the virtual area frame.

9. The electronic device of claim 1, further comprising:
a second camera configured to track a gaze of the user and arranged in the first direction of the body,
wherein the instructions, when executed by the at least one processor individually or collectively, cause the electronic device to:
track the gaze of the user via the second camera; and
based on the hand of the use entering within the first distance spaced apart from the touch sensor, position the virtual pointer object at a central position of a direction of the tracked gaze of the user.

10. The electronic device of claim 3, wherein the instructions, when executed by the at least one processor individually or collectively, cause the electronic device to:
display an inside of the virtual area frame as a grid having a N*M array of grid areas based on switching to the third mode.

11. The electronic device of claim 10, wherein the at least one virtual object comprises a plurality of virtual objects, and
wherein the instructions, when executed by the at least one processor individually or collectively, cause the electronic device to:
based on the plurality of virtual objects being present in the virtual area frame in the third mode, enlarge a space of the virtual area frame by a ratio, to display the virtual area frame as overlapping at least a portion of the XR content screen.

12. The electronic device of claim 1, wherein the instructions, when executed by the at least one processor individually or collectively, cause the electronic device to:
calibrate an error range for a touch input position detected by the touch sensor and a position of the virtual object output according to a gaze direction of the user.

13. An method of an electronic device supporting XR content, the method comprising:
outputting an extended reality (XR) content screen including at least one virtual object via a display of the electronic device;
based on identifying that a hand of a user is within a first distance from a touch sensor of the electronic device based on information obtained through at least one of the touch sensor or a plurality of first cameras of the electronic device, controlling the display to change the hand of the user displayed in the XR content screen to a virtual pointer object displayed in the XR content screen;
based on a touch input being detected via the touch sensor, controlling the display to display a virtual area frame including the virtual pointer object in the XR content screen, the virtual area frame having a size corresponding to a touch sensor area of the touch sensor; and
controlling motion of the virtual pointer object in the virtual area frame through a motion vector designated in correspondence to a touch input vector detected via the touch sensor.

14. The method of claim 13, wherein the displaying of the virtual pointer object further comprises:
tracking a gaze of the user via a second camera of the electronic device; and
positioning the virtual pointer object at a central position of a direction of the tracked gaze of the user based on the hand of the user being within the first distance spaced apart from the touch sensor.

15. The method of claim 13, wherein the outputting of the extended reality (XR) content screen to the display further comprises:
based on identifying that the hand of the user is positioned at a distance farther than the first distance from the touch sensor, displaying the XR content screen on the display in a first mode in which a hand-shaped object corresponding to the hand of the user is displayed in the XR content screen;
based on the hand of the user entering within the first distance, to display the XR content screen on the display, displaying the XR content screen on the display in a second mode in which the hand-shaped object is changed to the virtual pointer object; and
based on detection of a touch input via the touch sensor, displaying the XR content screen on the display in a third mode in which the virtual area frame is displayed in the XR content screen.

16. The method of claim 15, wherein the displaying the XR content screen on the display in a second mode further comprises:
determining a motion vector of a hand gesture; and
controlling the motion of the virtual pointer object by increasing a movement distance of the motion vector of the hand gesture by a set magnification ratio.

17. The method of claim 15, wherein the displaying the XR content screen on the display in a second mode further comprises:
displaying an entirety of the XR content screen in a plurality of grid areas having a N*M array of grid areas according to a plurality of settings; and
displaying a first grid area corresponding to a position of the virtual pointer object, among the plurality of grid areas, as a highlighted grid area.

18. The method of claim 15, wherein the displaying the XR content screen on the display in a third mode further comprises:
displaying an inside of the virtual area frame as a grid having a N*M array of grid areas.

19. The method of claim 13, further comprising:
changing the size of the virtual area frame when a multi-touch gesture to expand or reduce the size of the virtual area frame is received; and
changing a motion vector value of the virtual object by a magnification ratio corresponding to the changed size of the virtual area frame.

20. A non-transitory computer-readable recording media having recorded thereon a program that is executed by at least one processor of an electronic device to perform the method of claim 13.
